(19) United States
(12) Patent Application Publication
(10) Pub. No.: US 2016/0179206 A1
(43) Pub. Date: Jun. 23, 2016

(54) WEARABLE INTERACTIVE DISPLAY SYSTEM

(71) Applicant: Tim LaForest, Kalkaska, MI (US)

(72) Inventor: Tim LaForest, Kalkaska, MI (US)

(21) Appl. No.: 14/692,688

(22) Filed: Apr. 21, 2015

Related U.S. Application Data
(60) Provisional application No. 62/095,581, filed on Dec. 22, 2014.

(51) Int. Cl. G06F 3/01; G02B 27/01; G09G 3/20; A63B 24/00; G06F 3/16

(52) U.S. Cl. CPC G06F 3/017; A63B 24/0087; G06F 3/167; G09G 3/2096; G02B 27/0172; G09G 2310/08; G02B 2027/0178; G02B 2027/014

(57) ABSTRACT

A wearable interactive display system for synchronizing video sequence playback on a wearable viewing device with user movement. The wearable interactive display system comprises a viewing assembly, typically embodied as goggles or other head mounted interface, and a simulation system embodied on a mobile computer device. The viewing assembly is configured through a data connection with the simulation system to display recorded video sequences in a manner that is synchronized with the movement or verbal commands of a user. The mobile computer device simulation includes a simulation software application that includes a plurality of user selectable integrated display sequences that are adapted to reflect a travel path environment and is operative in synchronize the playback of such sequences with the movement of a user. In many embodiments, user movement is captured from an exercise machine being used by the user and connected to the mobile computer device.

### CROSS REFERENCE TO RELATED APPLICATIONS

This application claims the benefit of and incorporates by reference co-pending U.S. provisional patent application Ser. No. 62/095,581 filed Dec. 22, 2014.

### BACKGROUND OF THE INVENTION

1. Field of the Invention

This invention relates generally to wearable display systems and, more particularly, to interactive display goggles for playing a video recording that is synchronized with the movement of a user.

2. Description of the Prior Art

The operation and use of conventional treadmills, stationary cycles, and other of stationary exercise machines that simulate walking, running or pedaling (referred to collectively herein as simply “treadmills”) is well established. A problem which still exists, however, is that using a treadmill for an extended period of time is often very monotonous and boring. A user's only escape from the treadmill may be to simply stare at information screens on the treadmill or watch unrelated programming on nearby televisions. Thus, there remains a need for a wearable interactive display system with integrated goggles that allows a user to experience an interactive video while exercising or a treadmill or other exercise machine. It would be helpful if such a wearable interactive display system used the movements of the user on the exercise machine to control the video playback. It would be additionally desirable for such a wearable interactive display system to be implemented through a software application housed on a mobile computer equipped with voice control features to provide an alternate or supplemental means of controlling the video playback.

The Applicant's invention described herein provides for a wearable interactive display system adapted to display a video recording in a manner which is synchronized with the movement of the user. The primary components in Applicant's wearable interactive display system are viewing goggles and a simulation system. When in operation, the wearable interactive display system enables a user to experience different environments, such as cities, nature, or buildings while exercising through recordings that are synchronized to correspond play back with movement. As a result, many of the limitations imposed by prior art structures are removed.

### SUMMARY OF THE INVENTION

A wearable interactive display system for synchronizing video sequence playback on a wearable viewing device with user movement. The wearable interactive display system comprises a viewing assembly, typically embodied as goggles or other head mounted interface, and a simulation system embodied on a mobile computer device. The viewing assembly is configured through a data connection with the simulation system to display recorded video sequences in a manner that is synchronized with the movement or verbal commands of a user. The mobile computer device simulation includes a simulation software application that includes a plurality of user selectable integrated display sequences that are adapted to reflect a travel path environment and is operative in synchronize the playback of such sequences with the movement of a user. In many embodiments, user movement is captured from an exercise machine being used by the user and connected to the mobile computer device.

It is an object of this invention to provide a wearable interactive display system with integrated goggles that allows a user to experience an interactive video while exercising or a treadmill or other exercise machine.

It is another object of this invention to provide a wearable interactive display system that used the movements of the user on the exercise machine to control the video playback.

It is yet another object of this invention to provide a wearable interactive display system implemented with a software application housed on a mobile computer integral with alternate additional user interface control features to additionally enable control of the video playback through gestures and spoken command.

These and other objects will be apparent to one of skill in the art.

### BRIEF DESCRIPTION OF THE DRAWINGS

FIG. 1 is a front view of the components of a virtual reality treadmill system built in accordance with the present invention.

### DETAILED DESCRIPTION OF THE INVENTION

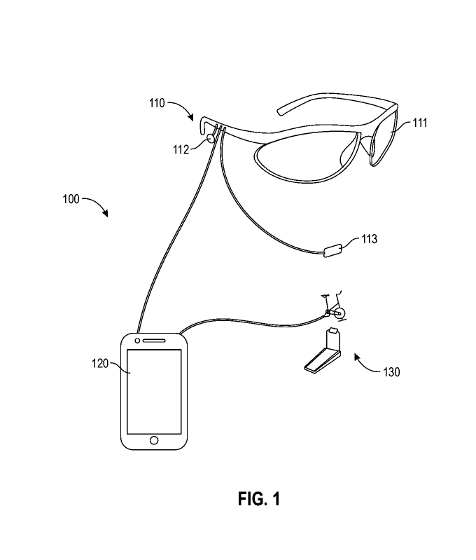

Referring now to the drawings and in particular FIG. 1, a wearable interactive display system 100 is shown having a viewing assembly 110 and a simulation system embodied on a mobile computer device 120. The viewing assembly 110 includes a conventional head mounted display, embodied as goggles 111 with an integrated display adapted to display recorded video (in an alternate embodiment, computer generated images may be used or integrated into the recorded video), an ear bud 112, a microphone 113, and a serial connection to the mobile computer device 120. The viewing assembly 110 is connected to the simulation system 120 through a wired serial data connection and through this serial connection, the goggles 111 are able to display for a wearer recorded video sequences stored on or otherwise accessible to the simulation system 120 and the ear bud 112 is able to play for a wearer audible related to the video.

It is contemplated that in an alternate embodiment, the viewing assembly 110 may be connected to the simulation system through a wireless serial data connection, such as a Bluetooth connection, or a wired or wireless network data connection.

The mobile computer device 120 housing the simulation system includes a processor and a non-volatile memory module, with the processor configured to execute instructions from a simulation software application housed at least in part on a non-volatile memory. The mobile computer device 120 is connected to an exercise machine 130 (i.e. treadmill, stationary cycle, elliptical machine, etc.) that is to be used by a user of the wearable interactive display system 100 through a wired serial data connection and through this serial connection, it receives data from the exercise machine 130 concerning a rate of movement at present. It is contemplated that in an alternate embodiment, the mobile computer device 120 may be connected to the exercise machine 130 through a wireless serial data connection, such as a Bluetooth connection, a wired or wireless network data connection, or other electronic data transferring means.

The simulation software application includes a plurality of user selectable integrated display sequences that are adapted to reflect a travel path environment. For example, a forest nature walk/ride sequence would comprise in the preferred embodiment a first person recording of a person moving through such an environment, broadcasting the visual and audible sights and sounds associated therewith for one who would be traversing through the forest. The simulation software application would additional synchronize the present speed at which a user is moving on the exercise machine 130 with the rate at which the user traverses through the simulated display sequence, allowing a user who moves faster on the exercise machine 130 to move faster through the simulated display sequence.

It is contemplated that such a synchronization of video playback with user movement could enable a user to take virtual tours of remote locales while on the treadmill. For example, a Paris sequence may include video that replicates, by the video shown, a first person “walk” through an actual street in Paris. It is contemplated that such a Paris sequence would be developed by the making of a video recording while moving through the desired street(s) and/or some computer generated sequence which mimic a desired street/block/area in Paris. It is understood that the movement synchronization may be selectively set at 1 to 1, where each step on the treadmill roughly corresponds to a step in the video, or an alternate ratio such as 10 to 1, where each step is the equivalent to 10 steps in the video.

It is contemplated that such viewing sequences may be selectably added to or accessed by a simulation system at any point by conventional means of computer data transfer, such as downloading or streaming from a remote server.

In an alternate embodiment, the viewing assembly 110 includes built in motion sensors, such as a pedometer, gyroscope and accelerometer, to enable it to determine the motion of a user and communicate such information to the simulation system for use in synchronization of video playback. In such an embodiment, it is understood that the exercise machine 130 is not necessary. In some instances, however, the motion sensors may be used in conjunction with the exercise machine for accounting for head movement into the synchronization. Accordingly, as a user looks side to side, the video playback can respond by panning side to side in a manner which corresponds to the head motion.

In a similar embodiment, a pedometer may be built into the simulation system for use in synchronization of video playback.

In one embodiment, the simulation system and software application additionally include a natural language user interface operative through the microphone 113 to enable selection and control of the features of the simulation, including movement through the video. Through this feature, the wearable interactive display system 100 may be employed to enable a user to simply view or tour a recording of a scene or area while seated.

In yet another embodiment, the simulation system and software application include peripheral remote motion sensing input devices, such as motion sensing cameras, placed in the immediate vicinity of a user, for sensing the movements of a user and enabling the control the synchronization of video playback through a natural user interface using gestures and spoken command. It is contemplated that in one implementation, the motion sensing input devices include an RGB camera, depth sensor and multi-array microphone to provide full-body 3D motion capture, facial recognition and voice recognition capabilities, similar to a conventional X-BOX® Kinect® natural user interface.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A wearable interactive display system for synchronizing video sequence playback with user movement, comprising:
a viewing assembly adapted to display video sequences;
a simulation system in communication to said viewing assembly, wherein said simulation system is configured to condition video sequences for display on said viewing assembly; and
a control interface in communication with said simulation system, wherein said control interface is operative to receive user input as at least one of user movement and user sound, generate electrical signals from said user input, and transmit said electrical signals to the simulation system; and
said conditioning of video sequences defined by the synchronization of the playback of such video sequences with user input.

2. The wearable interactive display system of claim 1, wherein the viewing assembly is wearable.

3. The wearable interactive display system of claim 2, wherein the viewing assembly is embodied as goggles with an integrated display adapted to display recorded video, an ear bud, a microphone.

4. The wearable interactive display system of claim 1, wherein the conditioning of video sequences includes synchronizing the playback of video sequences with user movement at a selectable ratio.

5. The wearable interactive display system of claim 1, wherein the control interface defines at least one of a treadmill and exercise bicycle.

6. The wearable interactive display system of claim 1, wherein the control interface is built in to at least one of the viewing assembly, the simulation system, and an exercise machine defined as at least one of a treadmill and exercise bicycle.

7. The wearable interactive display system of claim 1, wherein the control interface is embodied as peripheral remote motion sensing input devices.

8. The wearable interactive display system of claim 1, wherein the control interface includes at least one of a microphone, pedometer, gyroscope and accelerometer.

9. A wearable interactive display system for synchronizing video sequence playback with user movement, comprising:
a wearable viewing assembly adapted to display video sequences;
a wearable simulation system in communication to said viewing assembly, wherein said simulation system is configured to condition video sequences for display on said viewing assembly; and
an exercise machine, wherein the exercise machine includes a first control interface in communication with said simulation system, wherein said first control interface is operative to receive first user input as user movement, generate electrical signals from said first user input, and transmit said electrical signals to the simulation system; and
said conditioning of video sequences defined by the synchronization of the playback of such video sequences with first user input.

10. The wearable interactive display system of claim 9, wherein:
the viewing assembly includes a second control interface in communication with said simulation system;
said second control interface is operative to receive second user input as user movement, generate electrical signals from said second user input, and transmit said electrical signals to the simulation system; and
said conditioning of video sequences defined by the synchronization of the playback of such video sequences with first user input and said second user input.

11. The wearable interactive display system of claim 10, wherein second control interface at least a gyroscope and accelerometer.

12. The wearable interactive display system of claim 9, wherein:
the viewing assembly includes a second control interface in communication with said simulation system;
wherein said second control interface is operative to receive second user input as user sound, generate electrical signals from said second user input, and transmit said electrical signals to the simulation system; and
said conditioning of video sequences defined by the synchronization of the playback of such video sequences with first user input and said second user input.
